(19) United States
(12) Patent Application Publication
(10) Pub. No.: US 2018/0208212 A1
(43) Pub. Date: Jul. 26, 2018

(54) User Interface Device for Selecting an Operating Mode for an Automated Drive

(71) Applicant: Bayerische Motoren Werke Aktiengesellschaft, Muenchen (DE)

(72) Inventors: Philipp Suessenguth, Muenchen (DE); Lutz Lorenz, Muechen (DE); Marc Breisinger, Muechen (DE); Julia Niemann, Muechen (DE); Julian Eichhorn, Muechen (DE)

(21) Appl. No.: 15/934,512

(22) Filed: Mar. 23, 2018

Related U.S. Application Data
(63) Continuation of application No. PCT/EP2016/068750, filed on Aug. 5, 2016.

(30) Foreign Application Priority Data
Sep. 25, 2015 (DE) 10 2015 218 444.7

(51) Int. Cl. B60W 50/08; B60K 35/00

(52) U.S. Cl. CPC B60W 50/082; B60W 50/085; B60K 35/00; B60W 2540/04; B60K 2350/1056; B60W 2720/125; B60W 2750/308; B60K 2350/1028; B60K 2350/1048; B60W 2720/103

(57) ABSTRACT

A user interface device is configured to select an operating mode for an automated drive in a motor vehicle. The user interface device has a switching device to switch over between different driving automation stages of a motor vehicle, a selection device to determine at least one driving parameter in order to configure the driving automation stage selected by the switching device, and a display device which interacts with the selection device in order to display available selection possibilities for the at least one driving parameter when configuring the selected driving automation stage. It is thus possible to select and configure one of multiple driving automation stages of the motor vehicle even in the event of a plurality of such stages and configuration possibilities for the stages using a simple and space-saving operating design with only two different input types; namely, the switch-over between the driving automation stages and the configuration process using the selection device.

### CROSS REFERENCE TO RELATED APPLICATIONS

This application is a continuation of PCT International Application No. PCT/EP2016/068750, filed Aug. 5, 2016, which claims priority under 35 U.S.C. § 119 from German Patent Application No. 10 2015 218 444.7, filed Sep. 25, 2015, the entire disclosures of which are herein expressly incorporated by reference.

### BACKGROUND AND SUMMARY OF THE INVENTION

The present invention relates to a user interface apparatus for selecting a mode of operation for automated driving in a motor vehicle and to a steering apparatus for a motor vehicle, particularly a steering wheel, having such a user interface apparatus.

Modern motor vehicles, particularly automobiles, trucks and buses, have a series of systems for assisting the driver in driving the motor vehicle. These systems include firstly different information systems that provide the driver with information relevant to the control of the vehicle (speed displays, navigation system, etc.) and further driver assistance systems that assist the driver in normal or dangerous situations. In particular, many driver assistance systems can warn about identified deviations from a desired behavior, for example a distance from the vehicle ahead that is appropriate to the current speed, or can even take action independently to correct the deviation within the context of semi-automated driving. Systems for semiautomated driving of the vehicle have also already been in use for quite some time, and one need only think of automatic speed regulation (for the most part referred to as “automated cruise control, ACC”), in which a target speed can be set and the vehicle keeps to this target speed of its own accord—as far as possible—without this requiring the gas pedal to be operated as appropriate. Automatic parking assistance systems are also known. In addition, a subject of current research and development is designs and prototypes for highly automated and even autonomous driving. In the case of highly automated driving, the vehicle is controlled in predominantly fully automated fashion, and the driver himself needs to take action only in a few defined driving situations. In the case of autonomous driving, the vehicle is controlled fundamentally in fully automated fashion and the driver need neither take action himself nor monitor the automated driving.

Even if a motor vehicle is equipped for semiautomated, highly automated or even autonomous driving, it may be desirable to provide the driver with the option of selecting between the different driving automation levels available in the vehicle, particularly between manual control and one or more automated driving automation levels of the vehicle, depending on the situation. In daily commuter traffic, particularly in traffic jams, for example, it can thus be desirable to travel in highly automated or autonomous fashion, whereas manual driving could be preferred for journeys on an open country road or in particularly demanding surroundings, such as in the mountains, for example.

A steering wheel concept developed with this in mind by the automobile supplier TRW was presented at the 2014 Motor Show in Geneva as part of a study vehicle. In this design, the steering wheel can be moved to the side. This allows the driver either to steer the vehicle himself, to hand over control to the front-seat passenger or to park the steering wheel in the middle of the vehicle in automated driving mode, for example in order to be able to read. A display in the steering wheel displays whether the vehicle is being steered manually or in automated fashion and when the transfer between the two driving modes is complete. Some control functions are integrated in the steering wheel, others are realized by means of voice control. The steering wheel of the design from TRW has different modes: the “Driver Mode Manager” shows an “A” in a display when the vehicle is in automated mode. If the driver takes the steering wheel, an “M” signals readiness to hand over. If the transparent “Push-to-Drive” switch is operated, the driver can take control of the vehicle again. On the other hand, if the driver releases the steering wheel in manual mode, the display changes from “M” to “A” and the vehicle travels in automated fashion again. The driver uses a “Push-to-Talk” (PTT) switch to activate the voice input of the vehicle, by means of which different functions can be controlled.

In yet further known solutions, a multiplicity of respectively assigned input elements are provided in order to render the different driving automation levels available in the vehicle and the settings thereof selectable for the driver.

The invention is based on the object of further improving the control for selection and setting of driving automation levels available in the motor vehicle.

A first aspect of the invention relates to a user interface apparatus for selecting a mode of operation for automated driving in a motor vehicle. The user interface apparatus has a switching apparatus for changing over between different driving automation levels of a motor vehicle, a selection apparatus for stipulating at least one driving parameter for configuring the driving automation level selected by means of the switching apparatus and a display apparatus, interacting with the selection apparatus, for displaying available selection options for the at least one driving parameter during the configuration of the selected driving automation level.

A “motor vehicle” within the context of the invention is intended to be understood to mean any type of land vehicle that is moved by machine power without being based on rails. In particular, automobiles, trucks, motorcycles and buses are each motor vehicles within the context of the invention.

A “user interface apparatus for selecting a mode of operation for automated driving in a motor vehicle” is intended to be understood within the context of the invention to mean an apparatus by means of which a driver of the motor vehicle can set, or activate or deactivate, a mode of operation for automated driving, particularly a driving automation level and possibly one or more associated driving parameters.

A “driving automation level” within the context of the invention is intended to mean a degree of automation for the driving or control of the vehicle. In particular, manual driving (including with the additional use of driver assistance systems), semiautomated driving, highly automated driving and autonomous driving are driving automation levels within the context of the invention.

A “driving parameter” within the context of the invention is intended to mean a parameter for configuring an associated driving automation level, insofar as the latter has at least one setting option, such as a target or maximum speed, for example. The setting option can relate particularly to a numerical value or a mode of operation.

A “switching apparatus for changing over between different driving automation levels” within the context of the invention is intended to be understood to mean an apparatus for selecting and activating one of multiple selectable driving automation levels of a motor vehicle while simultaneously deactivating the other driving automation levels. In this case, a more highly automated driving automation level can include one or more, particularly also all of the, automated functions of one or more of the less automated driving automation levels.

Thus, selection and configuration of one or multiple driving automation levels of the motor vehicle is made possible, even when there are a multiplicity of such levels and configuration options therefor, with the aid of a simple and space-saving control design with just two different types of input, namely changing over between the driving automation levels and configuration by means of the selection apparatus. This is advantageous particularly when the user interface apparatus is arranged on a control apparatus with severely limited space owing to function or design, for example on a steering wheel spoke. In addition, the display apparatus is used to provide user guidance by means of selection display and preferably also feedback for the current selection, so that the user interface apparatus can also be controlled “blind”, i.e. without the driver's eyes needing to be directed at it. In this way, the underlying object is achieved.

Preferred embodiments of the user interface apparatus and the developments thereof are described below, each of these, unless expressly ruled out, being able to be combined with one another and with the subsequently described second aspect of the invention in any way.

According to a first preferred embodiment, the switching apparatus has at least three switching positions corresponding to different driving automation levels of the motor vehicle. These at least three driving automation levels can be selected particularly from the following levels: manual driving, semiautomated driving, highly automated driving, autonomous driving. Particularly for semiautomated driving, there may also be provision for multiple semiautomation levels differing in their degree of automation and for a corresponding number of switching positions corresponding thereto. Preferably, the switching apparatus has precisely three switching positions, particularly for manual driving, semiautomated driving and autonomous driving. In this manner, it is firstly possible for the entire range of automation, from manual driving (no automation) to autonomous driving (full automation), to be covered, configuration of the applicable automation levels (particularly for semiautomated driving) being possible by means of the selection apparatus. Secondly, the selection demands on the driver have only little complexity on account of the small number of driving automation levels.

According to a further preferred embodiment, the switching apparatus has an appropriate switch for each driving automation level for the purpose of changing over to this driving automation level. The applicable switches, i.e. at least one of them, may be embodied particularly as pushbutton switches, preferably such that the number of keys belonging to the switching apparatus corresponds to the number of driving automation levels or switching positions available. In this manner, fast and reliable changeover to the respective desired driving automation level can be assisted, since the control of keys is very simple and is also possible “blind”. In particular, the position of the keys can be remembered particularly easily. The keys may preferably be arranged in ordered fashion, i.e. in a sorted order according to the degree of automation of the corresponding automation levels. This also promotes “blind” selection of the desired driving automation level by means of haptic identification of the applicable key or of the position thereof relative to the other keys of the switching apparatus.

According to a further preferred embodiment, the selection apparatus is operable multidimensionally and, at least when a driving automation level for semiautomated driving is selected by means of the switching apparatus, the operation of the selection apparatus along a first selection dimension is used to select one of multiple driving parameters for the selected driving automation level and the operation of the selection apparatus along a second selection dimension is used to select a setting for the selected driving parameter.

In this case, a “selection dimension” within the context of the invention is intended to be understood to mean a type of operation for the selection apparatus that the latter is able to distinguish from any other available type of operation, so that each of the available selection dimensions can be assigned a separate meaning, particularly functionality, that the selection apparatus can identify when it is operated accordingly. In particular, one selection dimension can correspond to a control option for the selection apparatus along a first direction in space, and another selection dimension can correspond to an applicable control option along a second, different direction in space. In this case, it is particularly possible for the two directions also to be perpendicular to one another and, for example, to define an X direction (e.g. left/right) and a Y direction perpendicular thereto (e.g. up/down), along each of which the selection apparatus is controllable. A control option along one direction may particularly be the moving of a slider or tilting of a switching lever along the direction or the making of a gesture for a touch sensitive surface along the direction. In this case, forward and backward directions are preferably combined to give the same selection dimension, so that, for example, control along the positive X direction and control along the opposite direction (that is to say in the negative X direction) are part of the same selection dimension. Analogously, a selection dimension may also be determined by direction of rotation (e.g. clockwise), particularly within one plane, and the opposite direction of rotation (e.g. counterclockwise) may in turn be part of the same selection dimension, or else may alternatively define a separate selection dimension.

According to a further preferred embodiment, the selection apparatus is also operable along a third selection dimension in order to select a further setting for the selected driving parameter or to activate or deactivate the selection made by means of the other selection dimensions. It is thus particularly possible for a first selection dimension to be used to select a driving parameter whose setting is stipulated by means of the second selection dimension and activated by means of the third selection dimension. The corresponding deactivation can also be depicted in the same manner. It is thus possible for a single selection apparatus, which also permits complex inputs on account of the separation of the different selection dimensions, to be used in a space-saving and easy-to-use manner to select and set driving parameters and activate this setting for the respective driving automation level activated by means of the switching apparatus.

According to a further preferred embodiment, the selection apparatus is designed to be operable at two levels along each of the first and a second selection dimension. This means that there are only two separate operation options for each of the first and second selection dimensions. In particular, the selection apparatus may be in the form of a switch that can move in two different directions (for example in the form of a slide switch or tumbler switch), the first selection dimension corresponding to a movement of the switch along a first direction, the two-level operation corresponding to a forward and backward movement of the switch along the first direction, and, for the second selection dimension, the same applying accordingly with regard to a second direction, which is different than the first direction. In this case, it should be noted that a limitation to two-level operation of the selection apparatus along a selection dimension cannot be equated with a restriction to just two executable positions for this selection dimension. Rather, the number of these selectable positions (particularly driving parameters and settings therefor) is fundamentally unlimited, since repeated control of the selection apparatus along the selection dimension allows step-by-step advancement from one position to the next position in the applicable control direction. This can particularly also be effected in rotating fashion as in a continuous loop. Alternatively, it is particularly possible for a first and a last position to be defined in which it is no longer possible to advance in the same control direction as that in which the applicable position was reached.

According to a further preferred embodiment, the selection apparatus has at least one of the following input elements: joystick; multidimensionally operable switch, particularly in the form of a tumbler switch or slide switch; rotary switch, wherein different directions of rotation correspond to different selection dimensions; touchscreen or trackpad. The input elements may particularly also be designed such that, after operation by the user, they can return to their initial position and from there can be operated again, particularly as in the aforementioned repeated operation along one direction. In this manner, a particularly space-saving solution is possible and also the “blind” control is facilitated, since the applicable input element is always at the same location at the beginning of its operation. In the case of joysticks or switches, the return can correspond to a real physical return to the initial position, whereas in the case of a touchscreen, a corresponding return can be realized virtually by an appropriate display. Insofar as the input element is a trackpad or a touchscreen, it may particularly, as customary, be in substantially rectangular form. Alternatively, however, many other shapes are also conceivable, particularly loop or circular arrangements, for example as in a scroll wheel.

According to a further preferred embodiment, the selection apparatus is set up to select and set at least one of the following driving parameters: distance from the vehicle ahead; vehicle speed or speed range; level of the lateral tracking; lane change; parking. The distance from the vehicle ahead may particularly be a desired distance or a minimum distance. The vehicle speed may particularly be a desired speed, maximum speed or minimum speed. The level of the lateral tracking can stipulate particularly the trend in the level of the directional correction as a function of the lateral deviation of the vehicle from a desired line within a lane, for example its imaginary center line. It is thus possible for this driving parameter to be used, for example, to choose between a gentler and/or later rise and a steeper and/or earlier rise in the directional correction for lane keeping. In the case of the lane change, the vehicle parameter can define particularly the direction of the lane change (to the left or to the right) or the selection of a desired target lane.

According to a further preferred embodiment, the switching apparatus and the selection apparatus are arranged physically adjacent to one another such that they can be controlled with the same finger of the hand, particularly with the thumb, even when the hand of the driver is fixed. It is thus possible, particularly solely by means of a pure finger movement, for both the switching apparatus and the selection apparatus to be controlled and for the control to be changed between the two.

According to a further preferred embodiment, the display apparatus is set up to display the available selection options for the at least one driving parameter during the configuration of the selected driving automation level with the aid of icons arranged next to one another. The icons may particularly be arranged along a straight or closed line, so that they can be run through serially to make a selection of a driving parameter or the setting thereof by means of the selection apparatus.

According to a further preferred embodiment, the display apparatus is set up to depict the selection—corresponding to a current operated state of the selection apparatus—of a driving parameter or the setting thereof in marked fashion. This can be effected, for example, with the aid of a graphical object (e.g. arrow) movable along the different selection options or by means of a change in the depiction of the currently selected selection option (e.g. color, size or background change, or inverted depiction).

According to a further preferred embodiment, the user interface apparatus moreover has a sensor for detecting a touch of the selection apparatus or of a cockpit element, surrounding the latter, of the vehicle by a human user. In this case, the display apparatus is set up to display the available selection options for the at least one driving parameter during the configuration of the selected driving automation level only if the sensor detects a touch. In this manner, the available selection options are selectively depicted on the display apparatus only if they are probably, as indicated by the sensor signal, meant to be available for making a selection. If the sensor signal does not indicate a current touch, on the other hand, the applicable display panel of the display apparatus can be used in another way. It is therefore expedient to arrange the sensor particularly so close to the switching apparatus or the selection apparatus or to a cockpit element in the immediate surroundings thereof that the sensor can identify the presence of a hand of the user when it is located in a position relative to the user interface apparatus such that the user can use it to perform appropriate control of the switching apparatus and the selection apparatus. In particular, the sensor may be arranged between a contact surface—preferred for the control of the user interface apparatus—for the hand on a cockpit element, for example on the steering wheel, and a control panel combining the switching apparatus and the selection apparatus.

According to a further preferred embodiment, the display apparatus has a combined instrument, a head-up display or a screen or is part of same. In this manner, the display apparatus may be implemented particularly by means of display systems that are already provided for other functionalities in the motor vehicle. In particular, such variable display apparatuses also afford the advantage that later changes or additions to the driving parameters to be displayed by the display apparatus, and the settings of said driving parameters, can easily be implemented solely at software or data level without this requiring hardware adjustments.

A second aspect of the invention relates to a steering apparatus for a motor vehicle, particularly a steering wheel, having a user interface apparatus according to the first aspect of the invention, including its various embodiments, developments and variants. The control apparatus may particularly be a multifunction steering wheel and the user interface apparatus may preferably be arranged on a steering wheel spoke or on the central portion of the steering wheel (particularly on the impact absorber). The respective statements made above for the user interface apparatus and its embodiments apply in equal measure to the steering apparatus according to the invention according to the second aspect of the invention.

Other objects, advantages and novel features of the present invention will become apparent from the following detailed description of one or more preferred embodiments when considered in conjunction with the accompanying drawings.

### BRIEF DESCRIPTION OF THE DRAWINGS

Further advantages, features and possible applications of the present invention will emerge from the detailed description below in connection with the figures, in which

FIG. 1 schematically shows a user interface apparatus according to a preferred embodiment of the invention; and

FIG. 2 schematically shows a preferred arrangement of the elements of the user interface apparatus with a control panel arranged on a steering wheel of a motor vehicle and a display apparatus in the form of part of a combined instrument.

### DETAILED DESCRIPTION OF THE DRAWINGS

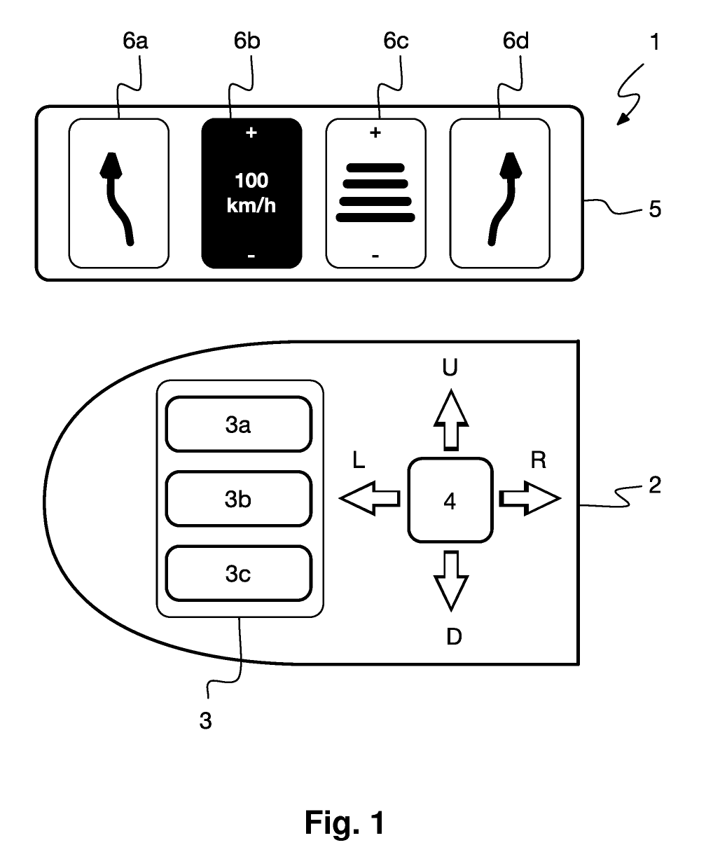

The user interface apparatus 1 shown in FIG. 1 firstly has a control panel 2, shown in the bottom part of the figure, on which are arranged a switching apparatus 3, in the form of a keypad, with three different key switches 3a, 3b and 3c and a selection apparatus 4 in the form of a two-dimensionally operable slide switch with an additional pushbutton function. Each of the keys 3a, 3b and 3c has a particular assigned driving automation level that can be activated by pressing the applicable key. It is thus possible for the key 3a, for example, to be configured to activate autonomous driving, the key 3b to be configured to activate semiautomated driving and the key 3c to be configured to activate manual driving. As soon as a key is pressed and therefore the assigned driving automation level is activated, the previously set driving automation level is deactivated. The keys 3a, 3b and 3c are therefore used to change over between the different driving automation levels.

The keys 3a, 3b and 3c and the selection apparatus 4 are arranged in direct proximity to one another on the control panel 2 such that the maximum distance between two of these control elements is no more than a few centimeters, particularly no more than 5 cm, and are therefore within the span of movement of a finger, particularly the thumb, of a hand of a young or adult human being. The selection apparatus 4 has a slide switch that can be moved forward and backward in each of two mutually perpendicular directions (i.e. selection dimensions) in the two dimensional plane of the control panel 2. In FIG. 1, these directions are denoted by L (for left) and R (for right) and by U (for up) and D (for down). The slide switch, when deflected along one of these directions, is subject to a restoring force, so that, when it is released again, it returns to its central initial position. In addition, the slide switch, at least when in its central initial position, can also be operated along a third direction, perpendicular to the other two directions or the plane of the image, by pressing it and can therefore also carry out the function of a key switch (further selection dimension). Therefore, the selection apparatus is in two-level form in each of the L/R direction and U/D direction and in one-level form in the direction of operation of the key switch running perpendicular thereto.

The upper part of FIG. 1 depicts the display apparatus 5 of the user interface apparatus 1 by way of example. The display apparatus 5 may be implemented particularly by means of a standard display or screen, for example on LCD or LED basis. Instead or in addition, special display elements are also conceivable. The display apparatus 5 is used to display driving parameters—where available—assigned to a driving automation level currently activated by means of the switching apparatus 3, and also possibly the setting of said driving parameters, by means of icons 6a to 6d. The icons 6a to 6d shown by way of example belong to the driving automation level for semiautomated driving.

In this case, the icons 6a and 6d represent the driving parameter “lane change” to the left or to the right, i.e. activation of the driving mode specifically represented by each of these allows the motor vehicle to be prompted to perform an appropriate lane change in automated fashion. In this case, the driver thus makes only the decision about the lane change itself and the direction thereof, as soon as he has communicated this to the vehicle by means of the selection apparatus 4, the vehicle carries out the lane change of its own accord. The icon 6b represents the driving parameter “speed of travel”, this particularly being able to be a desired speed, a maximum speed or a minimum speed for the motor vehicle. The icon 6c represents the driving parameter “distance from the vehicle in front”, this particularly being able to be a minimum distance to be kept from the vehicle in front. This minimum distance may be variable, particularly on the basis of speed, so that the input does not represent an absolute length statement, but rather indicates, for example, the degree of the distance to be kept, e.g. “short distance”, “average distance” or “long distance”.

In FIG. 1, the driving parameter “speed of travel” is selected at present, this being indicated to the driver by inversion of the applicable icon 6b (dark background and light text). Repeated operation, if need be, of the slide switch of the selection apparatus 4 along the L/R direction can be used to change between the different icons and therefore the driving parameters assigned thereto. Repeated operation, if need be, of the slide switch along the U/D direction, by contrast, can be used to select a setting or value assignment for the driving parameter selected previously along the L/R direction. Every single operation of the slide switch results in a skip to the next icon/driving parameter or to the next driving parameter setting in accordance with the direction of operation.

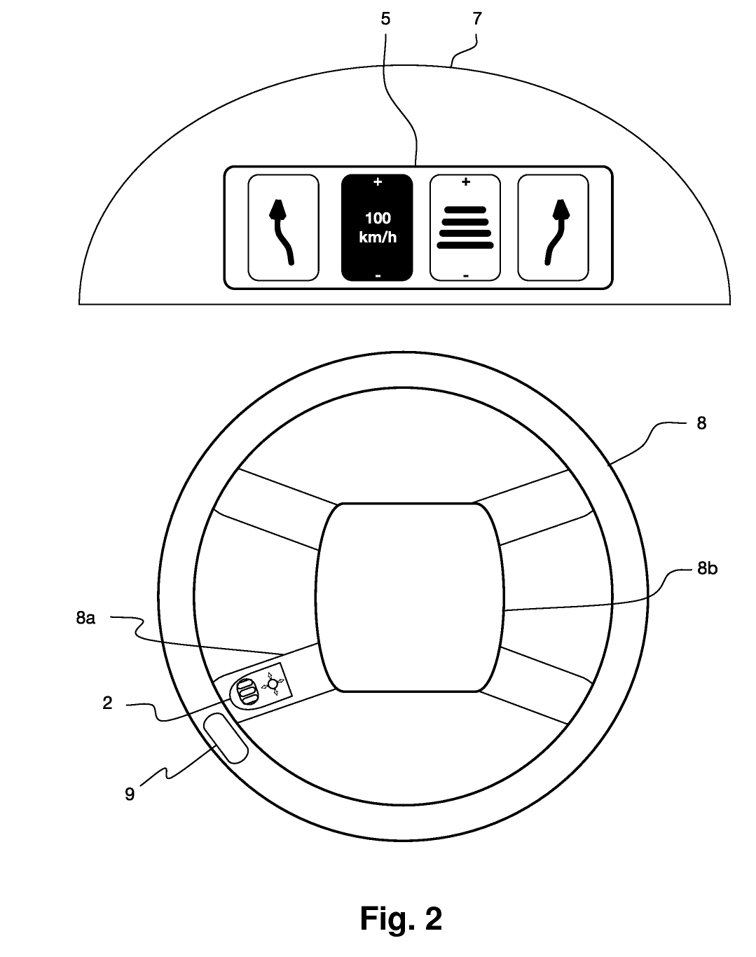

FIG. 2 shows a preferred arrangement of the user interface apparatus 1 in the motor vehicle. In this case, the display apparatus 5 is integrated in a combined instrument or head-up display 7, which is customary particularly in automobiles, trucks and buses, and is thus in a regular field of vision of the driver. The control panel 2 is arranged on a steering wheel spoke 8a of a steering wheel 8 such that, when the steering wheel is grasped by the left hand of the driver close to the steering wheel spoke 8a, his thumb can reach and control all of the control elements of the control panel 2, i.e. both the keys 3a-c of the switching apparatus 3 and the slide switch of the selection apparatus 4, even when the hand is fixed. Alternatively, the control panel 2 may also be arranged in the central portion 8b of the steering wheel, which is also regularly referred to as the “impact absorber”. A region of the steering wheel 8 that is adjacent to the control panel 2 has a sensor 9 of the user interface apparatus 1 arranged in it that is set up to detect the presence of a human hand in this region. It is coupled to the display apparatus 5 via an appropriate controller (particularly a processor) such that said display apparatus can display information or symbols, particularly icons 6a-6d, corresponding to driving parameters or the setting options thereof only if the sensor identifies the presence of a hand. In a variant, it is also possible for the activation of the control panel or the evaluation of inputs thereon to be effected only in this case.

While at least one exemplary embodiment has been described above, it should be noted that a large number of variations in that regard exist. In this case, it should also be borne in mind that the exemplary embodiments described are only nonlimiting examples, and it is not the intention to thereby restrict the scope, usability or configuration of the apparatuses and methods described here. Rather, the description above will provide a person skilled in the art with instructions for implementing at least one exemplary embodiment, and it goes without saying that various changes can be made to the manner of operation and the arrangement of the elements described in an exemplary embodiment without, in so doing, departing from the subject matter respectively stipulated in the appended claims or from its legal equivalents.

### LIST OF REFERENCE SYMBOLS

1 User interface apparatus
2 Control panel
3 Switching apparatus
3a-c Keys for driving automation level selection
4 Selection apparatus, in particular multidimensional switch
5 Display apparatus
6a-d Icons
7 Combined instrument
8 Steering wheel
8a Steering wheel spoke
8b Central portion of the steering wheel, particularly impact absorber
9 Sensor

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A user interface apparatus configured to select a mode of operation for automated driving in a motor vehicle, the apparatus comprising:
a switching apparatus configured to change over between different driving automation levels of a motor vehicle;
a selection apparatus configured to stipulate at least one driving parameter for configuring the driving automation level selected by the switching apparatus; and
a display apparatus, interacting with the selection apparatus, configured to display available selection options for the at least one driving parameter during the configuration of the selected driving automation level.

2. The user interface apparatus as claimed in claim 1, wherein the switching apparatus has at least three switching positions corresponding to each of at least three driving automation levels of the motor vehicle.

3. The user interface apparatus as claimed in claim 2, wherein the at least three driving automation levels include at least three of a manual driving level, semiautomated driving level, highly automated driving level, and autonomous driving level.

4. The user interface apparatus as claimed in claim 2, wherein the switching apparatus has an appropriate switch for each of the at least three driving automation levels to change over to a corresponding one of the at least three driving automation levels.

5. The user interface apparatus as claimed in claim 1, wherein the selection apparatus is operable multidimensionally and, at least when the driving automation level for semiautomated driving is selected by the switching apparatus, the operation of the selection apparatus along a first selection dimension is used to select one of multiple driving parameters for the selected driving automation level and the operation of the selection apparatus along a second selection dimension is used to select a setting for the selected driving parameter.

6. The user interface apparatus as claimed in claim 2, wherein the selection apparatus is operable multidimensionally and, at least when the driving automation level for semiautomated driving is selected by the switching apparatus, the operation of the selection apparatus along a first selection dimension is used to select one of multiple driving parameters for the selected driving automation level and the operation of the selection apparatus along a second selection dimension is used to select a setting for the selected driving parameter.

7. The user interface apparatus as claimed in claim 4, wherein the selection apparatus is operable multidimensionally and, at least when the driving automation level for semiautomated driving is selected by the switching apparatus, the operation of the selection apparatus along a first selection dimension is used to select one of multiple driving parameters for the selected driving automation level and the operation of the selection apparatus along a second selection dimension is used to select a setting for the selected driving parameter.

8. The user interface apparatus as claimed in claim 5, wherein the selection apparatus is further operable along a third selection dimension in order to select a further setting for the selected driving parameter or to activate or deactivate the selection made by one or more of the first and second selection dimensions.

9. The user interface apparatus as claimed in claim 6, wherein the selection apparatus is further operable along a third selection dimension in order to select a further setting for the selected driving parameter or to activate or deactivate the selection made by one or more of the first and second selection dimensions.

10. The user interface apparatus as claimed in claim 7, wherein the selection apparatus is further operable along a third selection dimension in order to select a further setting for the selected driving parameter or to activate or deactivate the selection made by one or more of the first and second selection dimensions.

11. The user interface apparatus as claimed in claim 5, wherein the selection apparatus is configured to be operable at two levels along each of the first and the second selection dimension.

12. The user interface apparatus as claimed in claim 8, wherein the selection apparatus is configured to be operable at two levels along each of the first and the second selection dimension.

13. The user interface apparatus as claimed in claim 1, wherein the selection apparatus has at least one of the following input elements:
a joystick;
a multidimensionally operable switch comprised of a tumbler switch or a slide switch;
a rotary switch having different directions of rotation correspond to different selection dimensions; and
a touchscreen or trackpad.

14. The user interface apparatus as claimed in claim 1, wherein the selection apparatus is configured to select and set at least one of the following driving parameters:
a distance from a vehicle ahead;
a vehicle speed or speed range;
a level of the lateral tracking;
a lane change; and
a parking parameter.

15. The user interface apparatus as claimed in claim 1, wherein the switching apparatus and the selection apparatus are arranged physically adjacent to one another such that they can both be controlled with a single finger of a hand of a driver of the motor vehicle when the hand of the driver is fixed.

16. The user interface apparatus as claimed in claim 1, wherein the display apparatus is configured to display the available selection options for the at least one driving parameter during the configuration of the selected driving automation level with the aid of icons arranged next to one another.

17. The user interface apparatus as claimed in claim 1, wherein the display apparatus is configured to depict the selection, corresponding to a current operated state of the selection apparatus, of a driving parameter in a marked fashion.

18. The user interface apparatus as claimed in claim 1, further comprising a sensor configured to detect a human touch of at least one of the selection apparatus and a cockpit element surrounding the selection apparatus, wherein the display apparatus is configured to display the available selection options for the at least one driving parameter during the configuration of the selected driving automation level only if the sensor detects the human touch.

19. The user interface apparatus as claimed in claim 1, wherein the display apparatus comprises a combined instrument, a head-up display or a screen.

20. A steering wheel for a motor vehicle, having a user interface apparatus, wherein the user interface apparatus is configured to select a mode of operation for automated driving in a motor vehicle, the user interface apparatus comprising:
a switching apparatus configured to change over between different driving automation levels of a motor vehicle;
a selection apparatus configured to stipulate at least one driving parameter for configuring the driving automation level selected by the switching apparatus; and
a display apparatus, interacting with the selection apparatus, configured to display available selection options for the at least one driving parameter during the configuration of the selected driving automation level.
